(19) United States
(12) Patent Application Publication
(10) Pub. No.: US 2006/0066212 A1
(43) Pub. Date: Mar. 30, 2006

(54) Illumination device

(75) Inventors: Siang-Wen Wan, Sanchong City (TW); Yao-Ching Su, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/085,758

(22) Filed: Mar. 21, 2005

(30) Foreign Application Priority Data
Sep. 30, 2004 (TW) 93129571

(51) Int. Cl. H01J 1/62

(52) U.S. Cl. 313/493

(57) ABSTRACT

Illumination devices. An illumination device includes a body and a plurality of protrusions. The body comprises a plurality of curved passages and a plurality of intermediate walls. The curved passages are separated by the intermediate walls and interconnected and transversely arranged in parallel. The protrusions are disposed in the curved passages.

### BACKGROUND

The invention relates to illumination devices, and in particular to illumination devices utilized in liquid crystal displays.

Flat fluorescent lamps or cold cathode fluorescent lamps (CCFLs) are the main components of illumination devices in liquid crystal displays. A conventional CCFL comprises a glass tube with positive and negative electrodes disposed at each end thereof respectively. Mercury (Hg) and phosphorous materials are disposed in the glass tube. When a high pressure is applied to the positive and negative electrodes, electrons are emitted from one end. The electrodes are accelerated due to the high pressure, causing collisions with the Hg atoms in the tube. After collision with the Hg atoms, excess energy produces ultraviolet (UV) light. The UV light contacts the phosphorous materials to produce visible light. The flat lamps can be easily assembled such that manufacturing costs are reduced.

A conventional serpentine lamp is a commonly used flat fluorescent lamp. FIG. 1A is a plan view of a conventional serpentine lamp structure 100. FIG. 1B is a cross section viewed along line AA′ of FIG. 1A of the conventional serpentine lamp structure 100. As shown in FIGS. 1A and 1B, the conventional serpentine lamp structure 100 comprises a housing 14, a plurality of walls 12, a positive electrode E₁, and a negative electrode E₂ disposed in the housing 14. A lamp 10 is formed around the walls 12 in a curved path. The lamp 10 is contained in the housing 14. As shown in FIG. 1B, phosphor 16 is disposed on an inner wall 110 of the lamp 10.

Light emission efficiency of the fluorescent lamp directly varies with the discharge path length between the positive and negative electrodes E₁ and E₂. Thus, the longer the distance between the positive and negative electrodes E₁ and E₂, the longer the discharge path. Hence, as shown again in FIG. 1B, since electron gas produced by the positive and negative electrodes E₁ and E₂ contacts the phosphor 16 to produce light, the longer the discharge path of the lamp 10, the larger the contact area therebetween, and thus, the greater the light emission efficiency.

The contact area between the electron gas and the phosphor in the conventional flat lamp, however, is still not large enough, and thus, light emission efficiency is still insufficient.

### SUMMARY

Illumination devices are provided. An exemplary embodiment of an illumination device comprises a body and a plurality of protrusions. The body comprises a plurality of curved passages and a plurality of intermediate walls. The curved passages are separated by the intermediate walls and interconnected and transversely arranged in parallel. The protrusions are disposed in the curved passages.

The protrusions comprise a plurality of first protrusions and a plurality of second protrusions. The body further comprises a first plate and a second plate, facing the first plate. The second protrusions are disposed on the second plate, protruding in a direction toward the first plate. The first protrusions and the second protrusions are alternatively arranged, forming the curved passages.

The intermediate walls comprise a plurality of first intermediate walls and a plurality of second intermediate walls. The body further comprises a first sidewall and a second sidewall, facing the first sidewall. The first sidewall and the second sidewall are alternatively arranged and connect the first plate and the second plate. The first intermediate walls connect to the first sidewall. The second intermediate walls connect to the second sidewall.

The first protrusions are hollow. The first protrusions comprise an internal space, communicating with an exterior side of the body.

The second protrusions are hollow. The second protrusions comprise an internal space, communicating with an exterior side of the body.

The protrusions are trapezoidal, conical, or arch-shaped.

The illumination device further comprises a plurality of phosphorous materials, disposed on inner walls of the curved passages.

The illumination device further comprises a plurality of phosphorous materials, disposed on the protrusions.

The first plate and the second plate comprise glass.

Further provided is an illumination device comprising a body. The body comprises a plurality of curved passages, arranged along a Y-axis and intercommunicated. Each curved passage extends along an XZ-plane.

The XZ plane is formed by an X axis and a Z-axis, and the X-, Y-, and Z-axes are perpendicular to each other.

The body further comprises a first plate, a second plate, and a plurality of intermediate walls. The intermediate walls extending in a direction of the X-axis are arranged in parallel in a direction of the Y-axis. The first plate and the second plate are parallel to an XY-plane and perpendicular to the intermediate walls; the curved passages encircle the intermediate walls.

### DESCRIPTION OF THE DRAWINGS

Illumination devices can be more fully understood by reading the subsequent detailed description in conjunction with the examples and references made to the accompanying drawings, wherein:

FIG. 1A is a plan view of a conventional serpentine lamp structure;

FIG. 1B is a cross section viewed along line AA′ of FIG. 1A of the conventional serpentine lamp structure;

FIG. 2A is a local enlarged perspective view of an embodiment of an illumination device;

FIG. 2B is an exploded view of the illumination device with a plurality of curved passages;

FIG. 2C is a cross section viewed along line BB′ of FIG. 2A of the illumination device;

FIG. 3A is a perspective view of another embodiment of an illumination device;

FIG. 3B is a plan view of another embodiment of the illumination device;

FIG. 3C is a cross section viewed along line CC′ of FIG. 3A of the illumination device.

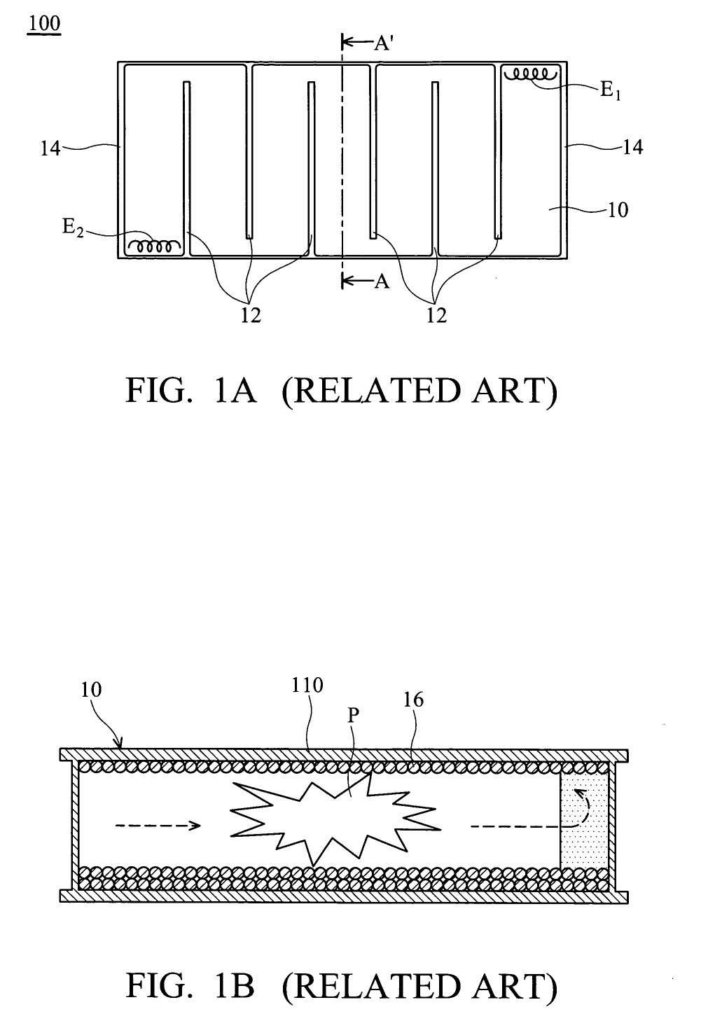

### DETAILED DESCRIPTION

Illumination devices are provided. An exemplary embodiment of an illumination device is applicable to a liquid crystal device.

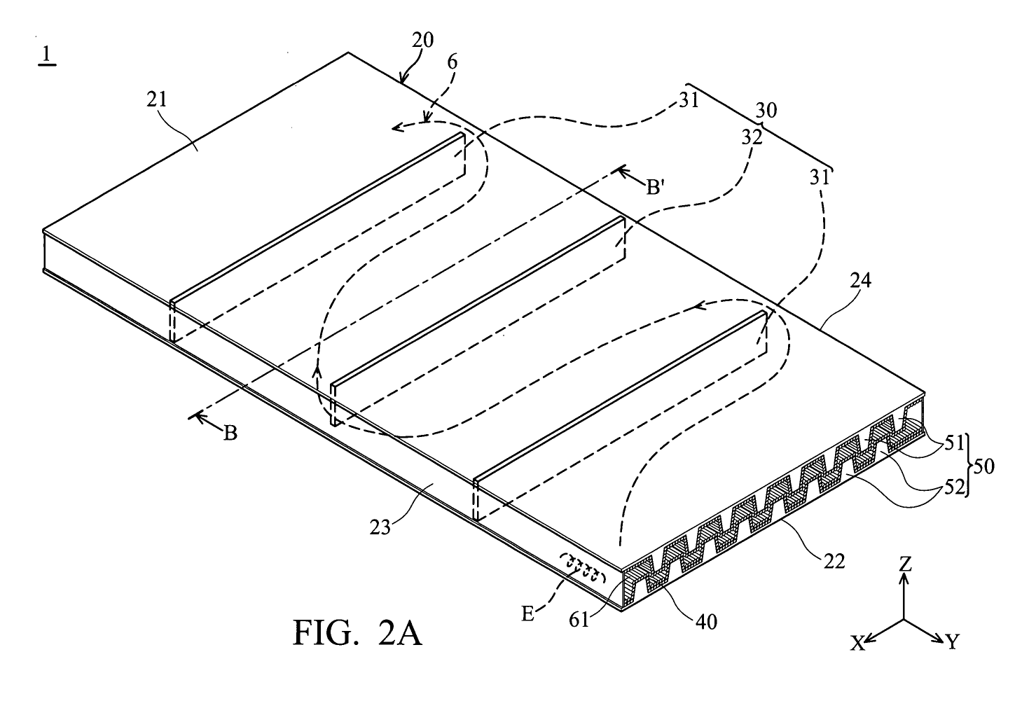

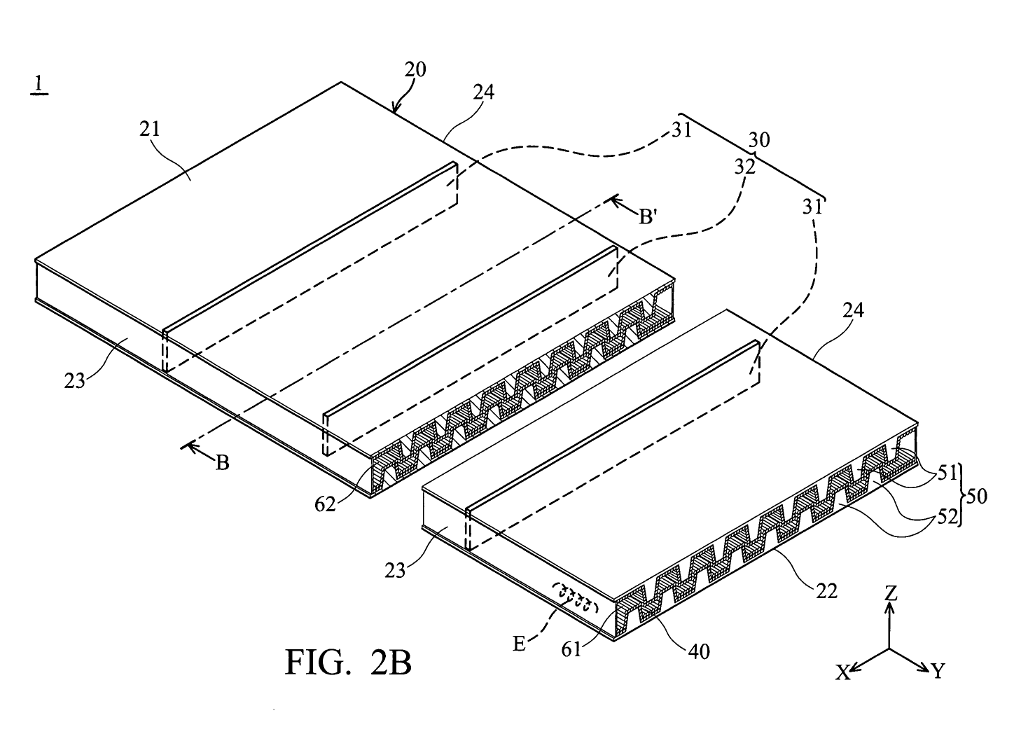

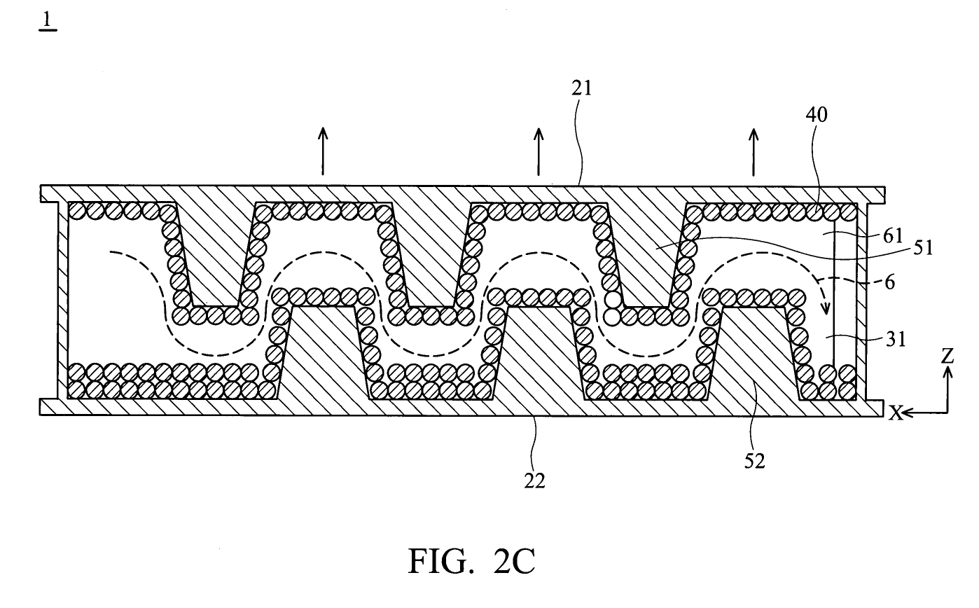

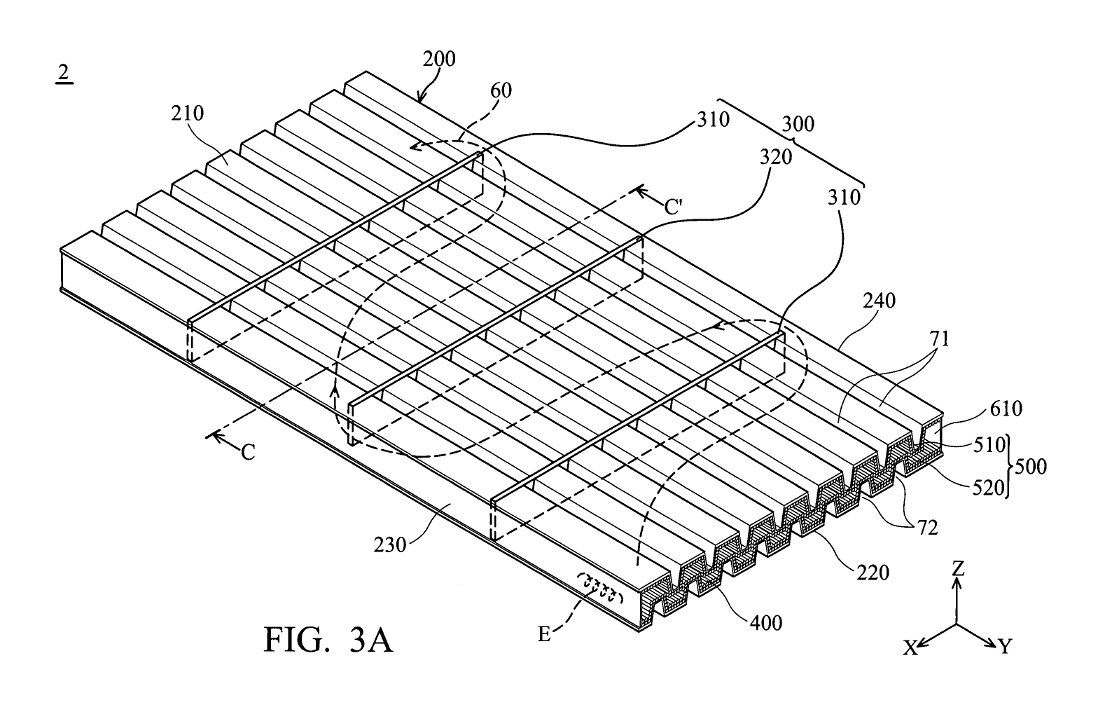

FIG. 2A is a local enlarged perspective view of an embodiment of an illumination device 1. FIG. 2B is an exploded view of the illumination device 1 with a plurality of curved passages 61, 62. FIG. 2C is a cross section viewed along line BB′ of FIG. 2A of the illumination device 1. Note that only two curved passages 61 and 62 are labeled in FIG. 2B, and the invention is limited to the number and length of the curved passages 61 and 62.

As shown in FIGS. 2A and 2B, the illumination device 1, disposed on an XY-plane, comprises a hollow body 20, a positive and a negative electrode, and a plurality of protrusions 50. To simplify the figure, only one of the electrodes E is shown, and the other electrode disposed on another end of the body 20 is omitted. The distance of the discharge path 6 between two electrodes depends on the length of the curved passages 61 and 62 in the body 20.

The body 20 comprises the curved passages 61 and 62, a first plate 21, a second plate 22, a first sidewall 23, a second sidewall 24, and a plurality of intermediate walls 30. A phosphorous material 40 is disposed on an inner wall of the curved passages 61 and 62. The curved passages 61 and 62 are separated by the intermediate walls 31 and interconnected and transversely arranged in parallel. That is, the curved passages 61 and 62 are intercommunicated and arranged transversely along a Y-axis. The transverse direction is the Y-axis direction. The lengthwise direction (the direction of the X-axis) is the direction the electron gas travels in the curved passages 61 or 62. Thus, each curved passage 61 or 62 extends along an XZ-plane. The XZ plane is formed by an X axis and a Z-axis, and the X-, Y-, and Z-axes are perpendicular to each other.

The first plate 21 and the second plate 22 of the body 20 comprise glass. The first plate 21 faces the second plate 22, and both are parallel to an XY-plane. The first sidewall 23 faces the second sidewall 24. The first sidewall 23 and the second sidewall 24 are alternatively arranged and connect the first plate 21 and the second plate 22. The intermediate walls 30 comprise a plurality of first intermediate walls 31 and a plurality of second intermediate walls 32, extending in the direction of X-axis, and arranged in parallel in the direction of Y-axis. The first and second intermediate walls 31 and 32 are alternatively arranged and perpendicular to the first sidewalls 23 and the second sidewalls 22. An end of each first intermediate wall 31 connects to the first sidewall 23, but the other end thereof does not contact the second sidewall 24. An end of each second intermediate wall 32 connects to the second sidewall 24, and the other end thereof does not contact the first sidewall 23. Thus, the curved passages 61 and 62 encircle the intermediate walls 31 and 32 and are intercommunicated in a roundabout way.

As shown in FIG. 2C, the protrusions 50 of the illumination device 1 comprise a plurality of first protrusions 51 and a plurality of second protrusions 52. The first protrusions 51 are disposed on the first plate 21. The second protrusions 52 are disposed on the second plate 22, protruding in a direction toward the first plate 21. The first protrusions 51 and the second protrusions 52 are alternatively arranged, forming the curved passages 61 and 62. The protrusions 50 are trapezoidal, conical, or arch-shaped. Note that the invention does not limit the shape of the protrusions 50. Since the curved passages 61 and 62 are formed by the protrusions 50, additional phosphorous materials 40 can be disposed on the protrusions 50 (or on the inner walls of the curved passages 61 and 62). Thus, the contact area between the electron gas and the phosphorous materials 40 is increased, and the discharge path 6 formed by each curved passage 61, 62 extending along the XZ-plane can be lengthened. Thus, light emission efficiency of the illumination device 1 can be greatly increased.

The manufacturing method of the curved passages of the illumination device 1 is described hereinafter.

The first protrusions 51, protruded from the first plate 21, and the second protrusions 52, protruded from the second plate 22, are formed by molding. The first plate 21 and the second plate 22 are connected by cold welding or press fitting. The first protrusions 51 and the second protrusions 52e are arranged alternatingly to form the curved passages 61 and 62.

Thus, the illumination device of the invention with curved passages arranged in parallel in a transverse direction such that contact area between the electron gas and the phosphorous materials can be increased, and the discharge path is increased accordingly to increase light emission and intensity.

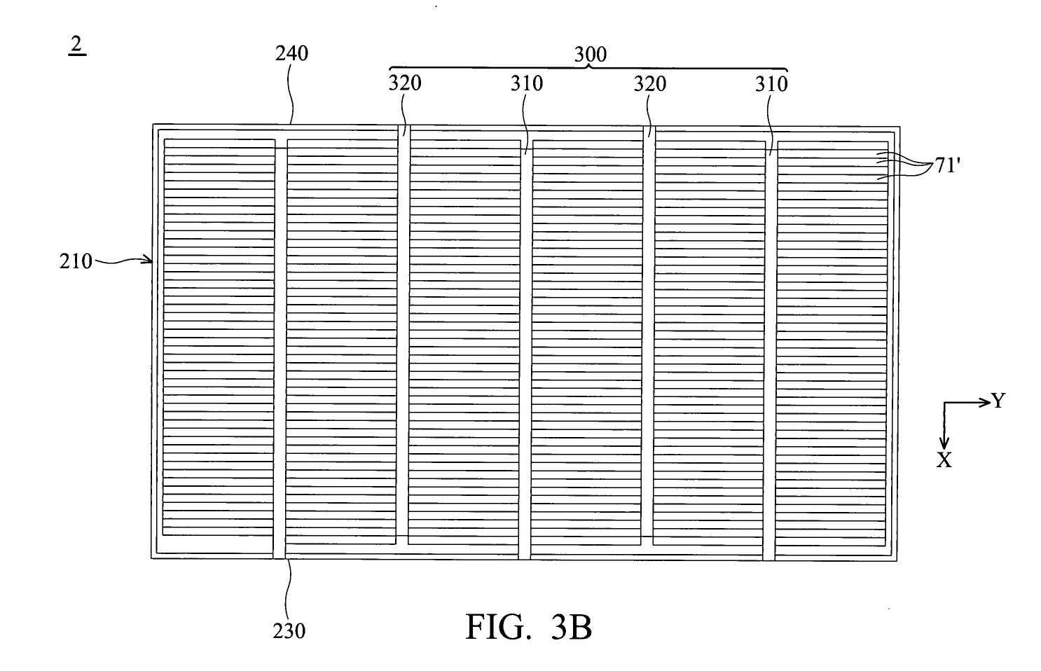

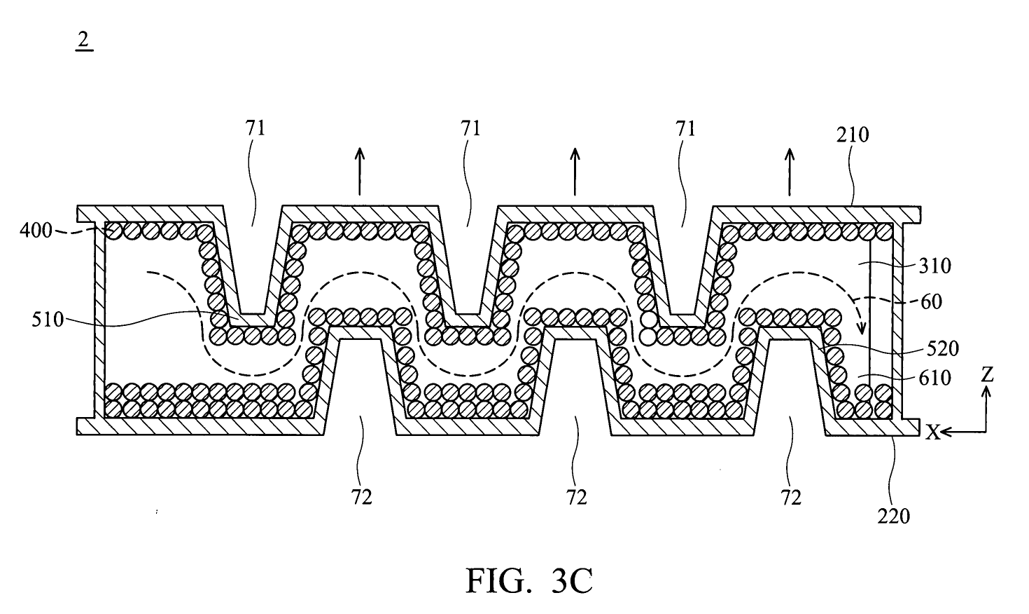

FIG. 3A is a perspective view of another embodiment of an illumination device 2. FIG. 3B is a plan view of another embodiment of the illumination device 2. FIG. 3C is a cross section viewed along line CC′ of FIG. 3A of the illumination device 2. The illumination device 2 comprises a hollow body 200, a positive and a negative electrode, and a plurality of protrusions 500. The hollow body 200 comprises a plurality of curved passages 610 and 620, a first plate 210, a second plate 220, a first sidewall 230, a second sidewall 240, and a plurality of intermediate walls 300. Phosphorous materials 400 are disposed on the inner walls of the curved passage 610. The protrusions 500 comprise a plurality of first protrusions 510 and second protrusions 520. The elements common to the previous embodiment are omitted here. The difference is that the first protrusions 510 are hollow. The first protrusions 510 comprise an internal space 71, formed by etching the first plate 210 such that the internal space 71 communicates with an exterior side of the body 200, as shown in FIGS. 3A and 3C. Similarly, the second protrusions 520 are hollow. The second protrusions 520 comprise an internal space 72, formed by etching the second plate 220 such that the internal space 72 communicates with an exterior side of the body 200.

Thus, in a top view, as shown in FIG. 3B, a plurality of grooves 71′ are formed in parallel in a transverse direction (in the direction of the X-axis) on the first plate 210. The grooves 71′ are formed by the internal space 71 of the first protrusions 510. Each groove 71′ extends in the direction of the Y-axis. Thus, the extending direction of the grooves 71′ is perpendicular to the extending direction of the curved passages 610 and 620. Moreover, although the second plate 220 is not shown, a plurality of grooves are also formed thereon.

The manufacturing method of the curved passages of the illumination device 2 is described hereinafter.

Please refer to both FIGS. 3B and 3C. The first protrusions 510 are formed by etching the first plate 210 to form an internal space 71 or grooves 71′ on the first plate 210. Thus, the first protrusions 510 are hollow. Similarly, the second protrusions 520 are formed by etching the second plate 220 to form an internal space 72 or grooves on the second plate 220. Thus, the second protrusions 520 are hollow.

In conclusion, the contact area between the electron gas and the phosphorus materials of the illumination device can be increased by increasing the discharge path to provide higher light emission efficiency and intensity.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An illumination device, comprising:
a body, comprising a plurality of curved passages and a plurality of intermediate walls, wherein the curved passages are separated by the intermediate walls and interconnected and transversely arranged in parallel; and
a plurality of protrusions, disposed in the curved passages.

2. The illumination device as claimed in claim 1, wherein the protrusions comprise a plurality of first protrusions and a plurality of second protrusions, and the body further comprises a first plate and a second plate, facing the first plate; the second protrusions are disposed on the second plate, protruding in a direction toward the first plate; the first protrusions and the second protrusions are alternatively arranged, forming the curved passages.

3. The illumination device as claimed in claim 2, wherein the intermediate walls comprise a plurality of first intermediate walls and a plurality of second intermediate walls; the body further comprises a first sidewall and a second sidewall, facing the first sidewall, with the first sidewall and the second sidewall alternatively arranged and connecting the first plate and the second plate, and wherein the first intermediate walls connect to the first sidewall; the second intermediate walls connect to the second sidewall.

4. The illumination device as claimed in claim 2, wherein the first protrusions are hollow.

5. The illumination device as claimed in claim 4, wherein the first protrusions comprise an internal space, communicating with an exterior side of the body.

6. The illumination device as claimed in claim 2, wherein the second protrusions are hollow.

7. The illumination device as claimed in claim 6, wherein the second protrusions comprise an internal space, communicating with an exterior side of the body.

8. The illumination device as claimed in claim 1, wherein the protrusions are trapezoidal, conical, or arch-shaped.

9. The illumination device as claimed in claim 1, further comprising a plurality of phosphorous materials, disposed on inner walls of the curved passages.

10. The illumination device as claimed in claim 1, further comprising a plurality of phosphorous materials, disposed on the protrusions.

11. The illumination device as claimed in claim 1, wherein the first plate and the second plate comprise glass.

12. An illumination device, comprising a body, comprising a plurality of curved passages, arranged along a Y-axis and intercommunicated, wherein each curved passage extends along an XZ-plane.

13. The illumination device as claimed in claim 12, wherein the XZ-plane is formed by an X-axis and a Z-axis, and the X-, Y-, and Z-axes are perpendicular to each other.

14. The illumination device as claimed in claim 13, wherein the body further comprises a first plate, a second plate, and a plurality of intermediate walls, extending in a direction of the X-axis and arranged in parallel in a direction of the Y-axis, and wherein the first plate and the second plate are parallel to an XY-plane and perpendicular to the intermediate walls; the curved passages encircle the intermediate walls.
